(19) United States
(12) Patent Application Publication
(10) Pub. No.: US 2025/0267319 A1
(43) Pub. Date: Aug. 21, 2025

(54) Systems And Methods For Managing, Tracking, And Inserting Content

(71) Applicant: Comcast Cable Communications, LLC, Philadelphia, PA (US)

(72) Inventors: Linlin Jiang, Beijing (CN); Xue Zhang, Beijing (CN); Qiang Wang, Beijing (CN); Yu Cao, Beijing (CN); Qi Zhang, Beijing (CN)

(21) Appl. No.: 18/582,319

(22) Filed: Feb. 20, 2024

Related U.S. Application Data
(63) Continuation of application No. PCT/CN2021/124645, filed on Oct. 19, 2021.

(51) Int. Cl. H04N 21/234; G06Q 30/0241; H04N 21/235; H04N 21/81

(52) U.S. Cl. CPC H04N 21/23424; G06Q 30/0241; H04N 21/235; H04N 21/812

(57) ABSTRACT

Systems, apparatuses, and methods are described for message classification and management. A message may indicate a request for placement of a content item, such as an advertisement or advertisement campaign, into one or more content streams. A message ID associated with the message may be converted to a bit vector to compare to one or more filter data sets. The comparison of the bit vector to the filter data sets may determine whether the message may correspond to a previous message, such as a previous advertisement or advertisement campaign. The message may be classified as a new message or an update message.

### CROSS-REFERENCE TO RELATED APPLICATIONS

This application is a continuation of and claims priority to PCT/CN2021/124645, filed Oct. 19, 2021, which is hereby incorporated by reference in its entirety.

### BACKGROUND

Media streams often include supplemental content that communicates with consumers to promote services and products. Supplemental content may be inserted into one or more media streams based on electronic orders received from other systems. Those orders may be modified, after initial ingestion or other processing by a digital video system. The digital video system may need to determine an order is an initial order or whether an order is an attempt to modify a previously ingested/processed order. But it may be difficult to efficiently search previous orders in a database. For example, a digital video system may receive millions of order during a given ingesting period. These and other shortcomings are addressed in the disclosure.

### SUMMARY

The following summary presents a simplified summary of certain features. The summary is not an extensive overview and is not intended to identify key or critical elements.

Systems, apparatuses, and methods are described for message classification and management. In one aspect, a computing device may receive, from a database or a third party system, a message that indicates a request for placement of a content item into one or more content streams. A message ID associated with the message may be converted to a bit vector to compare to one or more filter data sets. The comparison of the bit vector to the filter data sets may determine whether the message may correspond to a previous message, without obtaining that information from the database or the third party system. The message may be classified as a new message or a possible update message without querying a database that stores information associated with the previous messages. Avoiding such queries may reduce the processing time of message classification and/or save computational resources.

These and other features and advantages are described in greater detail below.

### BRIEF DESCRIPTION OF THE DRAWINGS

Some features are shown by way of example, and not by limitation, in the accompanying drawings In the drawings, like numerals reference similar elements.

FIG. 1 shows an example communication network.

FIG. 2 shows hardware elements of a computing device.

FIG. 3 is a diagram showing third party systems sending messages to a classification engine.

FIG. 4 shows examples of filtering operations.

FIGS. 5A-5B show examples of filtering operations based on multiple filter buffers.

FIGS. 6A-6C show examples of filter buffer cluster management.

FIGS. 7A-7B are a flow chart showing an example method for classification of incoming messages.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

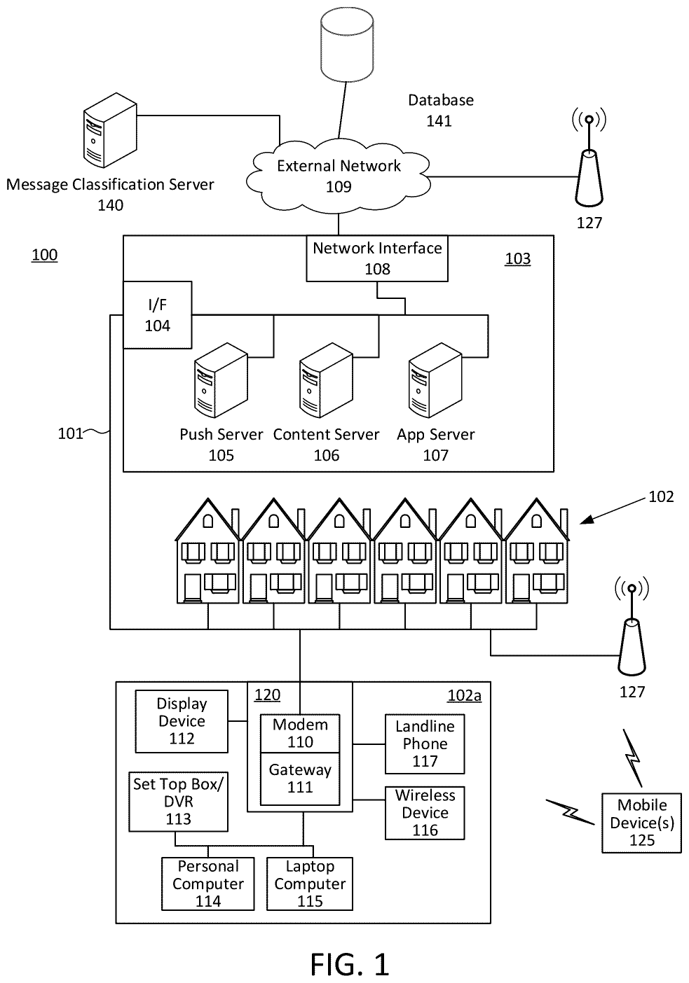

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as additional push, content, and/or application servers, and/or other types of servers. Also or alternatively, one or more servers may be part of the external network 109 and may be configured to communicate (e.g., via the local office 103) with computing devices located in or otherwise associated with one or more premises 102.

For example, a message classification server 140 may communicate with the local office 103 (and/or one or more other local offices), one or more premises 102, one or more access points 127, one or more mobiles devices 125, and/or one or more other computing devices via the external network 109. The message classification server 140 may perform message classification and/or other operations, as described below. Also or alternatively, the message classification server 140 may be located in the local office 103, in a premises 102, and/or elsewhere in a network. The message classification server 140 may communicate with a database 141. The database 141 may store data (e.g., data records that include information for placement/insertion of content items into content streams) from (and/or otherwise associated with) messages classified by the message classification server 140. The message classification server 140 and the database 141 may be part of a digital video system that places content items indicated by the messages into one or more content streams. Although shown as a separate element, the database 141 may be part of the message classification server 140. Also or alternatively, the push server 105, the content server 106, the application server 107, the message classification server 140, and/or other server(s) may be combined. The servers 105, 106, 107, and 140, other servers, and/or the database 141 may be computing devices and may comprise memory storing data and also storing computer executable instructions that, when executed by one or more processors, cause the server(s) to perform steps described herein.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

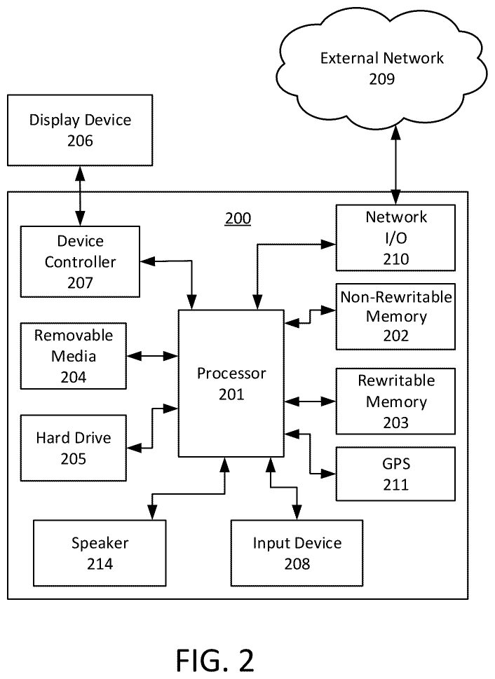

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, the message classification server 140, the database 141, any devices with the external network 109) and any other computing devices discussed herein. The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

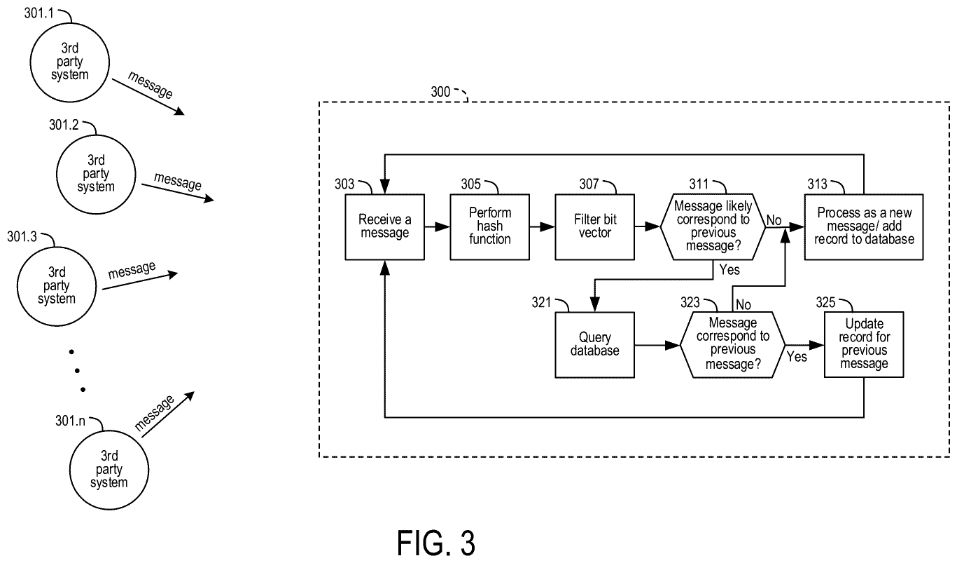

FIG. 3 is a diagram showing third party systems 301.1, 301.2, 301.3, . . . 301.n (collectively, “third party systems 301”; generically, “third party system 301”) sending messages that may be received (e.g., ingested) by a message classification engine 300. Also shown in FIG. 3, within the message classification engine 300, is flow chart showing examples of steps in a message classification method. The third party systems 301 may comprise servers or other computing devices that communicate messages, via a network (e.g., the external network 109), to one or more computing devices (e.g., the message classification server 140) performing operations of the message classification engine 300. Although FIG. 3 suggests the presence of n>4 third party systems 301, there may be any quantity (e.g., 1 or more) of such systems sending messages to the message classification engine 300 and/or to other message classification engines.

A message from a third party system 301 may comprise a digital order for inserting (e.g., placing) one or more content items (e.g., advertisement, information services, other supplemental content) into one or more content streams (e.g., linear TV broadcasting streams) and/or for otherwise causing output of one or more content items. The message may indicate one or more content items and may comprise a request and/or instructions for inserting and/or otherwise outputting one or more content items. A message may indicate a content item by comprising the content item (e.g., the content item may be part of or attached to the message). Also or alternatively, a message may indicate a content item by providing information (e.g., with a Uniform Resource Identifier (URI), a file name, a network address, a pointer, etc.) about where that content item is stored and/or from where that content item may be retrieved or otherwise obtained. Also or alternatively, the message may indicate a content item by providing an identifier of the content item. A request and/or instructions for inserting (and/or otherwise outputting) a content item may comprise specific instructions for inserting/outputting (e.g., specific content streams in which the content item is to be inserted, specific times for insertion, a quantity of insertions, etc.) Also or alternatively, a request and/or instructions for inserting and/or otherwise outputting a content item may comprise information that provides one or more criteria by which insertion/output may be determined (e.g., times, audience demographics, geographic or other regions, preferences, etc.).

The third party systems 301 may use different types of software for performing their operations and may send messages that comprise varying formats. For example, the third party systems 301 may not use a common format for identifiers or other information used to track messages. Also or alternatively, the third party systems 301 may not determine and/or track (and/or may not reliably determine and/or track) whether messages correspond to previous messages. A message may correspond to a previous message if, for example, the message includes information about a request or instruction associated with a previous message. Such a message may, for example, include one or more changes to an order/request for insertion/output (e.g., changing one or more of a time of insertion, a stream for insertion, a content item to be inserted, criteria for selecting stream(s) for insertion, etc.). A message may not correspond to a previous message if, for example, the message is a new/initial message regarding a particular request for insertion/output of one or more content items during a particular time period (e.g., the message may represent an initial order/request for such insertion during that time period).

A digital video system operating the message classification engine 300 may benefit from distinguishing between incoming messages that correspond to a previous message and those that do not. For example, different operations may be performed. If an incoming message corresponds to a previous message, there may be an existing data record (e.g., in the database 141) associated with that previous message. That record may, for example, comprise information about how one or more content items are to be inserted, information indicating where those content item(s) may be found (and/or may comprise those content item(s)), and/or other information. If an incoming message corresponds to a previous message, it may be computationally more efficient (and/or otherwise preferable) to update that data record instead of creating a new data record. Such updating may also conserve database storage capacity (e.g., by avoiding unnecessary duplicate records) and/or prevent insertion of content item(s) based on outdated request information. If an incoming message does not correspond to a previous message, creation of a new data record (e.g., in the database 141) may be appropriate.

Because one or more of the third party systems 301 may not reliably indicate whether a particular message corresponds to a previous message, one way of determining whether a received message corresponds to a previous message is to query, based on data from the received message, a database storing data records associated with previous messages. But this process may be slow and resource-intensive when a large number of messages are received. A separate database query may be required for each message, regardless of whether that message corresponds to a previous message for which there may be a data record. Database queries can be relatively slow, and each query may require temporarily locking a database, which locking may prevent other access to the database and/or otherwise cause latency in applications that rely on that database.

As described herein, one or more filter data sets, that may be contained in one or more filter buffers may be used to more efficiently determine whether received messages correspond to previous messages. Based on this determination, received messages may be processed as new messages or as updates to previous messages.

At step 303, the message classification engine 300 may receive a message from a third party system 301. The received message may indicate a content item and may comprise a request for insertion/placement/output of the content item. As indicated above, the message may comprise information identifying how one or more content items should be inserted into one or more content streams (e.g., designated market area (DMA), channel, information identifying a particular time/schedule for showing a content item, a budget for content item placement, indication of the content item(s) to be placed, and/or other information). The message may also comprise a message ID, label, and/or other information (e.g., numbers, letters, symbols) that may have been assigned by the third party system 301 that sent the message and that may be associated with a request from that third party system 301 for placement (e.g., insertion into one or more content streams) or other output of one or more content item(s). Sizes of messages may vary, but some messages (e.g., messages actually sending a content item for placement) may be large, and/or a large quantity of messages may be received.

At step 305, the message classification engine 300 may perform one or more hash functions on the unique identifier of the message and generate a bit vector. At step 305, the message classification engine 300 may filter the bit vector using a filter buffer. At step 311, the message classification engine 300 may determine, based on the filtering of step 305, whether the received message likely corresponds to a previous message.

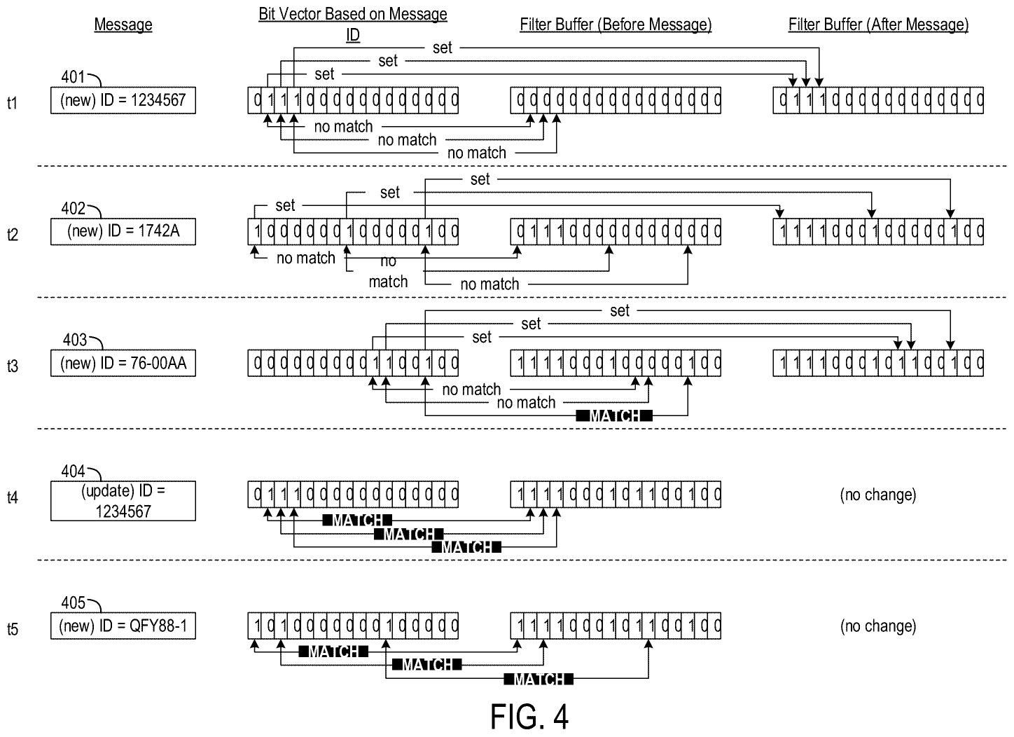

Steps 305, 307, and 311 may, for example, comprise use of a Bloom filter. FIG. 4 shows examples of operations associated with several iterations of steps 305, 307 and 311. Although FIG. 4 assumes the performance of one or more of steps 313, 321, 323, or 325 after performance of step 311 for a particular message, details of those steps are explained after the description of FIG. 4. FIG. 4 also includes labels “new” and “update” for messages. These labels are only for convenience and purposes of explanation, and actual messages may lack such labels.

At time t1, a first message 401 having a message ID “1234567” may be received. For purposes of the present example, it is assumed that the message 401 is a first message that has been received for a relevant time period. When step 305 is performed for the message 401, a bit vector (e.g., a bit array) “0111000000000000” may be generated based on the message ID 1234567. The bit vector may comprise a plurality of indices (e.g., bit positions) and each index may be associated with a bit value (e.g., 0 or 1). Although shown as a 16-bit vector in FIG. 4, any desired length may be chosen for bit vectors and filter buffers. To generate a bit vector, k hash algorithms may be separately applied to the message ID, with each of the k hash algorithms mapping the message ID to a different index of the bit vector. In the example of FIG. 4, k=3. Numerous types of hash algorithms, usable to map an arbitrary input to one of a plurality of an arbitrary quantity of bit positions, are known. Examples of such hash algorithms may comprise SpookyHash, mmh3, SHA1, and/or md5.

When step 307 is performed for the message 401, the bit vector generated for the message 401 may be filtered using a filter buffer. A filter buffer may comprise a data set (e.g., bit array) having a same number of bit positions (e.g., indices) as bit vectors that will be compared to the filter buffer. For purposes of the present example, it is assumed that the message 401 is a first message that has been received for a relevant time period. Accordingly, there may be no data records stored in a database based on received messages. For this reason, the filter buffer has not yet been updated to reflect stored data records, and stores a value of “0000000000000000.” Filtering of a bit vector using a filter buffer may comprise comparing the bit vector to the filter buffer and determining, for each bit set by one of the k hash algorithms during generation of the bit vector (e.g., for each “1” in the example of FIG. 4), whether a corresponding index of the filter buffer has a non-matching value. In the present example for the bit vector generated for the message 401, the second, third, and fourth indices contain “1,” but none of the corresponding second, third or fourth indices of the filter buffer contain “1,” so there are no matches. When step 311 is performed for the message 401, and based on the occurrence of at least one “no match” during the comparison of step 307, the message classification engine 300 may determine that the message 401 does not correspond to a previous message. After comparing the bit vector generated for the message 401 to the filter buffer, the filter buffer may be updated to indicate that a database may (e.g., based on step 313 described below) contain a data record associated with the message 401. As part of this updating, each of the indices of the filter buffer corresponding to an index of the bit vector set by one of the k hash algorithms (e.g., each of the indices with a “1”) may be set to include the same value as the corresponding bit vector index. In the current example, this results in setting the second, third, and fourth indices of the filter buffer to “1.”

At time t2, a message 402 having an ID “1742A” may be received. Performing step 305 on that ID, using the same k hash algorithms used for the message 401, generates a bit vector “1000000100000100” (e.g., a “1” in each of the first, eight and fourteenth indices). Performing step 307 on that bit vector, by comparing to the filter buffer after the update to the filter buffer based on the message 401, results in three “no match” determinations. When step 311 is performed for the message 402, and based on the occurrence of at least one “no match” during the comparison of step 307 performed for the message 402, the message classification engine 300 may determine that the message 402 does not correspond to a previous message. The filter buffer may then be updated, by setting values at the first, eighth, and fourteenth indices based on the bit vector for the message 402, to indicate that the database may contain a data record associated with the message 402.

At time t3, a message 403 having an ID “76-00AA” may be received. Performing step 305 on that ID, using the same k hash algorithms used for the messages 401 and 402, generates a bit vector “0000000001100100” (e.g., a “1” in each of the tenth, eleventh, and fourteenth indices). Performing step 307 on that bit vector, by comparing to the filter buffer after the update to the filter buffer based on the message 402, results in two “no match” determinations and one “match” determination. When step 311 is performed for the message 403, and based on the occurrence of at least one “no match” during the comparison of step 307 performed for the message 403, the message classification engine 300 may determine that the message 403 does not correspond to a previous message. The filter buffer may then be updated, by setting values at the tenth, eleventh, and fourteenth indices based on the bit vector for the message 403, to indicate that the database may contain a data record associated with the message 403.

At time t4, a message 404 is received. The message 404 is an update to the message 401 and has an ID (“1234567”) that is the same as that of the message 401. Performing step 305 on that ID, using the same k hash algorithms used for the messages 401, 402, and 403, generates a bit vector “0111000000000000” (e.g., a “1” in each of the second, third, and fourth indices). Performing step 307 on that bit vector, by comparing to the filter buffer after the update to the filter buffer based on the message 403, results in three “match” determinations. When step 311 is performed for the message 404, and based on the absence of a “no match” during the comparison of step 307 performed for the message 404, the message classification engine 300 may determine that the message 404 is likely to correspond to a previous message. The filter buffer may be updated based on the bit vector for the message 404, but because that bit vector is the same as a bit vector previously used to update the filter buffer, there is no change to the filter buffer. Optionally, and because that updating would not change the filter buffer, that updating may be omitted.

At time t5, a message 405 having an ID “QFY88-1” may be received. Performing step 305 on that ID, using the same k hash algorithms used for the messages 401, 402, 403, and 404, generates a bit vector “1010000000100000” (e.g., a “1” in each of the first, third, and eleventh indices). Performing step 307 on that bit vector, by comparing to the filter buffer after the update to the filter buffer based on the message 404 (or 403, if updating based on the message 404 is omitted), results in three “match” determination and no “no match” determinations. When step 311 is performed for the message 405, and based on the absence of a “no match” during the comparison of step 307 performed for the message 405, the message classification engine 300 may determine that the message 405 is likely to correspond to a previous message. In this case, however, the determination is a false positive. Although none of the bit vectors for the messages 401 through 404 is the same as the bit vector for the message 405, cumulative updates to the filter buffer based on those other bit vectors resulted in setting the first, third, and eleventh indices. In this case, the first index was set as part of the update based on the message 402 bit vector, the third index was set as part of the update based on the message 401 bit vector, and the eleventh index was set as part of the update based on the message 403 bit vector. As explained below, additional steps may be performed to keep the probability of a false positive at a predetermined level.

Returning to FIG. 3, if the message classification engine 300 determines at step 311 that a message is not likely to correspond to a previously-received message (e.g., that at least one bit vector index set by one of the k hash algorithms fails to match a bit value in a corresponding index of the filter buffer), step 313 may be performed. At step 313, a data record may be created in a database (e.g., the database 141) based on the received message. The data record may comprise a copy of the message, selected information from the message, and/or other information based on the message. That data record may, for example, comprise the message ID, an indication of one or more content items, information for placing or otherwise outputting the content item(s) (e.g., for inserting into one or more streams), and/or other information.

If the message classification engine 300 determines in step 311 that a message is likely to correspond to a previously-received message (e.g., that each bit vector index set by one of the k hash algorithms matches a bit value in a corresponding index of the filter buffer), step 321 may be performed. This step may be performed because false positives may be possible, as described above. At step 321, the message classification engine 300 may query the database (e.g., using query languages such as structured query language (SQL)) for a data record that corresponds to the message (e.g., query for a data record that contains the message ID of the message). At step 323, the message classification engine 300 may determine, based on the result of the query in step 321, whether the message corresponds to a previous message. If no (e.g., if the query returned no data record), step 313 may be performed. If yes (e.g., if the query returned a data record), step 325 may be performed. At step 325, the returned data record may be updated based on the message. The updating may, for example, comprise changing instructions, for placement of the content item in one or more content streams, from the previous message. For example, if the previous message indicates the placement of a content item in one or more content streams at a first time point and the message is an update message that indicates the placement of the content item in the one or more content streams at a second time point, the update may comprise changing instructions, for placement of the content item in the one or more content streams, from the first time point to the second time point. After step 325 or step 313, step 303 and subsequent steps may be repeated.

While false positives may occur based on the performance of steps 305, 307, and 311, the steps described in connection with FIG. 3 may improve the speed and efficiency of determining whether a received message corresponds to a previous message. Rather than querying a database (e.g., the database 141) for a data record when a message is received, the message classification engine 300 may use one or more filter buffers to more efficiently determine whether a received message corresponds to previous messages. To the extent that querying a database (e.g., the database 141) is necessary to determine whether a received message corresponds to a previous message, this may occur for only a subset of all the messages being received, because some messages have already been determined as not corresponding to previous messages. As a result, the number of queries to the database and the processing time of determining whether received messages correspond to previous messages may be reduced. In addition, the steps described in connection with FIG. 3 may be suitable for all scenarios of the advertising industry and/or other industries that require first deciding whether a message corresponds to a previous message and then performing a corresponding operation (e.g., create or update a data record corresponding to the message). The message classification engine 300 may efficiently categorize the corresponding operations for the received messages, without implementing a complex third party system tool.

As discussed above, filtering of bit vectors based on filter buffers may result in false positives. Additional steps may be performed to keep the probability of a false positive at a predetermined level. For a particular filter buffer and a corresponding set of k hash algorithms for use with a quantity of messages, the false positive rate may be represented by ε, with ε≈(1−e^{-kn/m})^{k}, and in which e is Euler's number, n represents a quantity of previous messages for which a filter buffer may be used to determine a potential correspondence with a newly received message (e.g., a number bit vectors generated for those previous messages messages), k represents a quantity of hash algorithms used to generate a bit vector for each message, and m represents a size of the filter buffer (e.g., a number of bit positions in the filter buffer). If values for m and k are fixed, an increase in n increases ε.

By selecting an acceptable false positive rate (e.g., an acceptable value for ε), and by using selected values for k and m, it is possible to calculate a quantity (n) of previous messages for which a filter buffer may be used to determine a potential correspondence with a newly received message. Further updating such a filter buffer based on bit vectors for additional messages may unacceptably increase the false positive rate for that filter buffer. However, this potential problem can be addressed by using and/or creating one or more additional filter buffers.

For example, if a first filter buffer has been cumulatively updated based on n different bit vectors generated for n messages, that first filter buffer may be made read-only (e.g., not further updatable), and a read/write (e.g., updatable) second filter buffer may be created. When a next message is received, a bit vector based on that next message (and generated using hash functions associated with the first filter buffer) may be filtered using (e.g., compared to) the first filter buffer. Instead of updating the first filter buffer, however, the second filter buffer may be updated based on another bit vector for that next message. That other bit vector may be generated using a different set of hash functions associated with the second filter buffer. When a further message is received, a first bit vector for that further message may be generated using the hash functions for the first filter buffer and filtered using the first buffer. A second bit vector for that further message may be generated using the hash functions for the second filter buffer and filtered using the second buffer, and the second filter buffer may be updated based on the second bit vector for that further message. This may continue until the second filter buffer has been updated based on n2 different bit vectors generated for n2 messages. The value n2 may be a threshold for the second filter buffer that is calculated similar to n, but that may be different from the value of n because of differences (e.g., quantity of bit positions, quantity of hash algorithms, acceptable ε value) between the first and second filter buffers. After the second filter buffer has been updated based on n2 different bit vectors, the second filter buffer may be made read-only (e.g., non-updatable), a third filter buffer may be created, and the pattern may be repeated.

The pattern may be repeated any number of times. In general, if there are 1 . . . f filter buffers, the 1^{st} through f−1^{th} filter buffers may be read-only (e.g., non-updatable), the f^{th} filter buffer may be read/writable (e.g., updatable), and received messages may be filtered using each of the f filter buffers. An overall false positive rate may be the sum of the individual false positive rates for each of the f filter buffers. But if added filter buffers are increased in size (relative to existing filter buffers) and/or the n-thresholds of those additional filter buffers are otherwise controlled, the overall false positive rate and/or the individual false positive rate for one or more of the added filter buffers may be kept sufficiently low. In this way, a method for classifying and/or processing received messages may be extensible without excessively increasing a false positive rate.

To keep the overall false positive rate and/or the individual false positive rate for one or more of the added filter buffers low, the message classification engine 300 may set or otherwise determine a contracting factor r (with 0<r<1) for the f filter buffers. For example, if the false positive rate of the first filter buffer is ε₁, the false positive rate of the second filter buffer may be ε₂=ε₁r. By setting r between 0 and 1,

$${ε}_{2} \leq {ε}_{1} \frac{1}{1 - r} .$$

The overall false positive rate for the f filter buffers may be ε_{f}=1−Πᵢ₌₁^{f-1}(1−ε₁rⁱ).

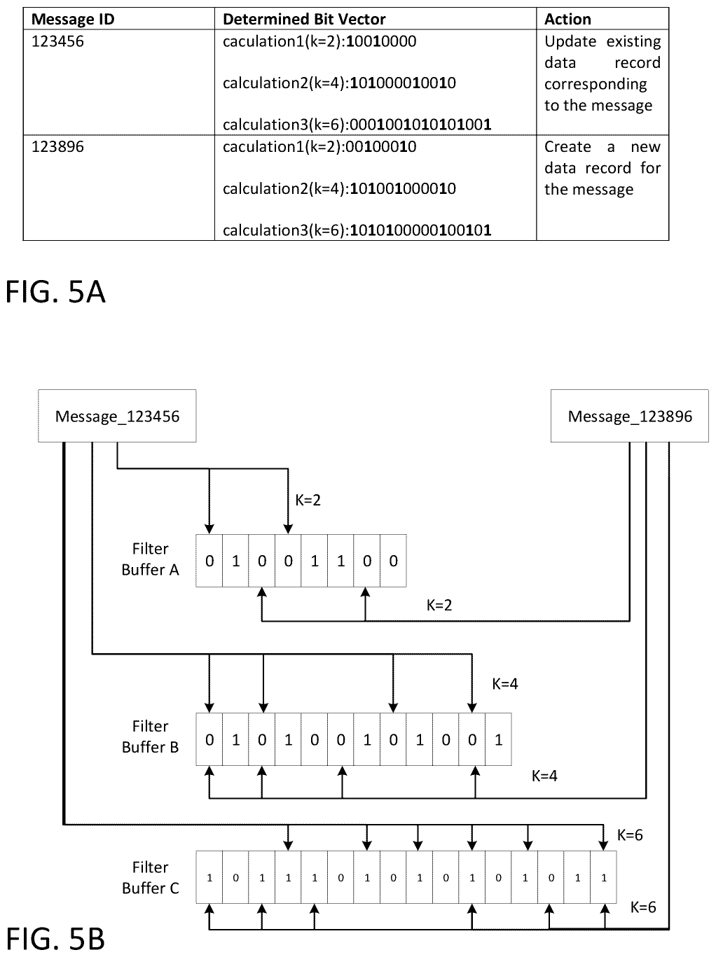

FIGS. 5A and 5B show examples of filtering operations based on multiple filter buffers. FIG. 5A shows examples of bit vectors generated for two messages and corresponding actions performed for those two messages. FIG. 5B shows comparison of the bit vectors shown in FIG. 5A and example filter buffers for determining whether those messages shown in FIG. 5A are likely to correspond to previous messages. As shown in FIG. 5B, three filter buffers (e.g., Filter Buffer A, Filter Buffer B, and Filter Buffer C) may be used to determine whether a message is likely to correspond to a previous message. The three filter buffers may be part of a filter buffer cluster. A filter buffer cluster may comprise one or more filter buffers and may be used to determine whether messages associated with a project (e.g., a particular time period, a particular advertising campaign, a single group of third party systems 301) are likely to correspond to previous messages. Within a filter buffer cluster, one or more filter buffers may be read-only, and one or more filter buffers may be read/writable, and/or one or more filter buffers may be set aside but not yet in use (e.g., certain memory has been allocated to those filter buffers but the filter buffers may not be readable or writable).

If all the filter buffers in a filter buffer cluster have been updated based on a threshold number of different bit vectors generated for a threshold number of messages, a read/write new filter buffer may be created. For example, in FIG. 5B, Filter Buffer B may be created after Filter Buffer A has been made read-only (e.g., because Filter Buffer A has been cumulatively updated based on n(A) different bit vectors generated for n(A) messages). Filter Buffer B may be a read/writable filter buffer. But after Filter Buffer B has been made read-only (e.g., because Filter Buffer B has been cumulatively updated based on n(B) different bit vectors generated for n(B) messages), Filter Buffer C may be created. Filter Buffer C may be a read/writable filter buffer. If Filter Buffer C has been cumulatively updated based on n(C) different bit vectors generated for n(C) messages, Filter Buffer C may be made read-only and an additional filter buffer may be created. This pattern may be repeated as many times as is needed or desired.

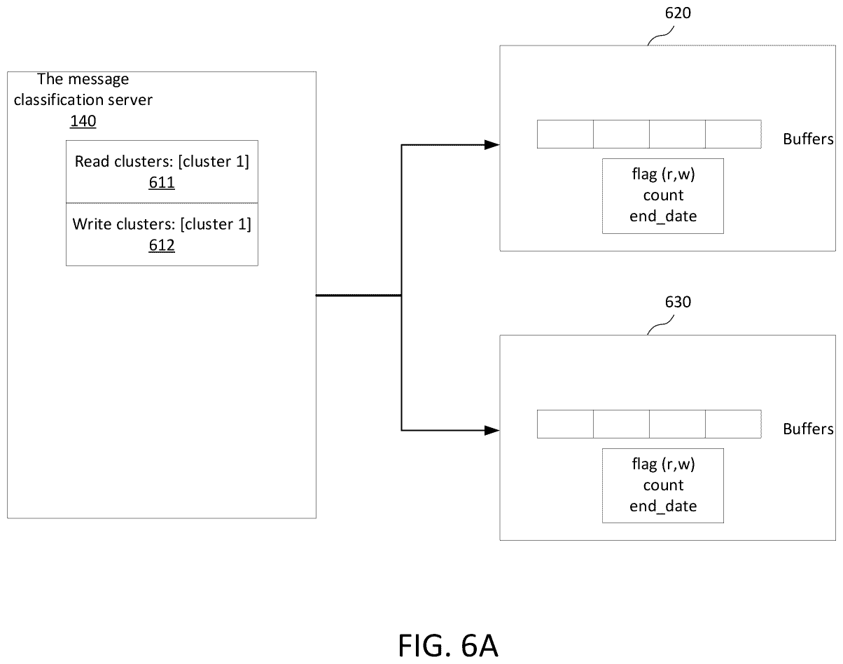

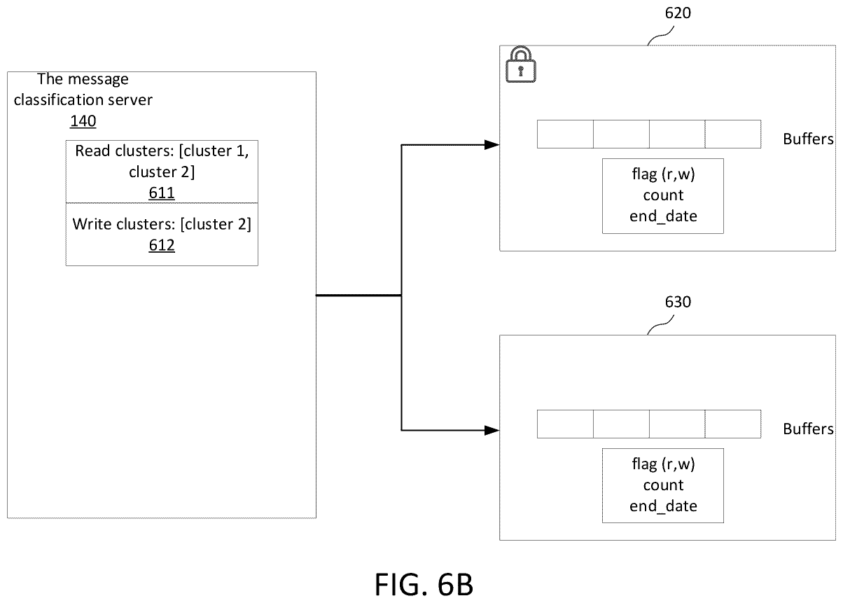

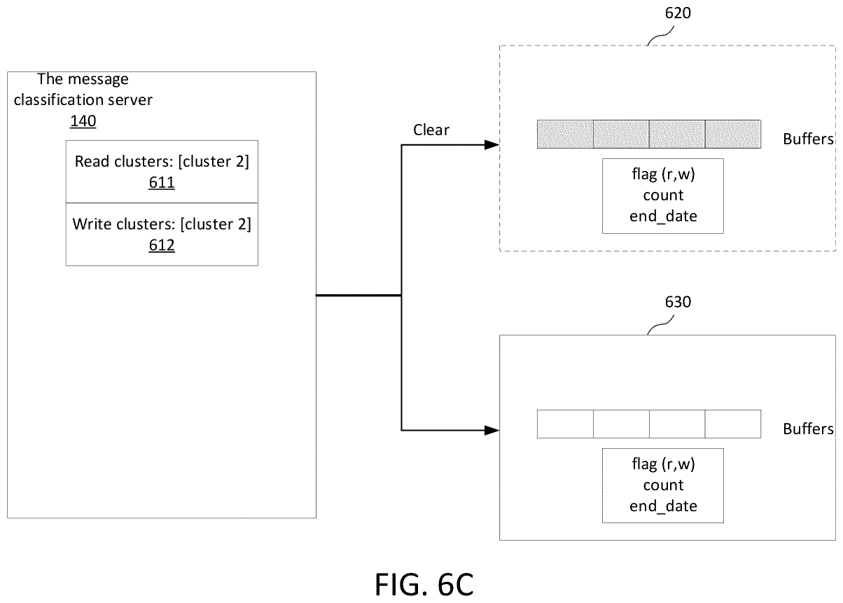

Also or alternatively, as further described in connection with FIGS. 6A-6C, if an amount of stored data records associated with a first filter buffer cluster has reached a threshold (e.g., a total number of messages for which the filter buffers in the first buffer cluster were updated has reached a threshold, the maximum amount of storage for the filter buffer cluster, etc.), a second filter buffer cluster with at least one new filter buffer may be created and/or activated. The first filter buffer cluster may be made read-only (e.g., none of the filter buffers in the first filter buffer cluster may be updatable) and the second filter buffer cluster may be read/writable (e.g., at least one filter buffer in the new filter buffer cluster is read/writable). A newly received message may be checked against each of the filter buffers in the first buffer cluster and each of the filter buffers in the second filter buffer cluster to determine whether the newly received message is likely to correspond to a previous message. A filter buffer in the second filter buffer cluster may be updated based on a bit vector for the newly received message generated based on the filter buffer in the new filter buffer cluster (e.g., using hash algorithms associated with the filter buffer). Third and additional filter buffer clusters may also be created.

In FIGS. 5A and 5B, a first bit vector for a message (e.g., a newly received message) may be generated using hash algorithms associated with Filter Buffer A because Filter Buffer A is the first filter buffer created in the filter buffer cluster or Filter Buffer A has a smallest size (e.g., the filter buffer that has the smallest number of elements) among all the filter buffers in the filter buffer cluster. Additional bit vectors for the message may be generated based on other filter buffers (e.g., Filter Buffer B, Filter Buffer C) if filtering the first bit vector based on Filter Buffer A results in at least one “no match,” as further described below.

For example, a first message having a message ID “123456” may be received. Three sets of hash algorithms may be applied to the first message and each resulting bit vector may be compared to a corresponding filter buffer. Different hash algorithms may be performed on each message based on each filter buffer (e.g., number of bit positions of filter buffer, false positive rate of filter buffer). For example, a first bit vector “10010000” (e.g., a “1” in each of the first and fourth indices) for the first message may be generated using hash algorithms associated with Filter Buffer A. Filter Buffer A may store a value of “01001100.” The arrows in FIG. 5B may correspond to bit positions of the bit vectors shown in FIG. 5A that were set to 1 by the corresponding hash algorithms. Comparing the first bit vector to Filter Buffer A results in two “no matches.” Filter Buffer A may be read-only and may not be updated based on the first bit vector for the first message because, for example, Filter Buffer A may have been cumulatively updated based on a threshold number of different bit vectors for Filter Buffer A. A second bit vector “101000010010” (e.g., a “1” in each of the first, third, eighth, and eleventh indices) for the first message may be generated using hash algorithms associated with Filter Buffer B. Filter Buffer B may store a value of “010100101001.” Comparing the second bit vector to Filter Buffer B results in four “no matches.” Filter Buffer B may be read-only and may not be updated based on the second bit vector for the second message because, for example, Filter Buffer B may have been cumulatively updated based on a threshold number of different bit vectors for Filter Buffer B. A third bit vector “0001001010101001” (e.g., a “1” in each of the fourth, seventh, ninth, eleventh, thirteenth, and sixteenth indices) for the first message may be generated using hash algorithms associated with Filter Buffer C. Filter Buffer C may store a value of “1011101010101011.” Comparing the third bit vector to Filter Buffer C results in six “matches” and zero “no match.” Based on the absence of “no match” for comparing the third bit vector for the first message to a corresponding filter buffer (e.g., Filter Buffer C), the first message may be determined to likely correspond to a previous message.

Filter Buffer C may be updated based on the third bit vector, but because that bit vector may be the same as a bit vector previously used to update Filter Buffer C, there is no change to Filter Buffer C. Optionally, because that updating would not change Filter Buffer C, that updating may be omitted. Based on the determination that the first message is likely to correspond to a previous message, a database (e.g., the database 141) may be queried for a data record that corresponds to the first message. Based on the result of the query, a corresponding action may be performed, as shown in FIG. 5A. If the query returns a data record corresponding to the first message, that data record may be updated.

As another example, a second message having a message ID “123896” may be received. Three sets of hash algorithms may be applied to the second message and each resulting bit vector may be compared to a corresponding filter buffer. For example, a first bit vector “00100010” (e.g., a “1” in each of the third and seventh indices) for the second message may be generated using the hash algorithms associated with Filter Buffer A. The hash algorithms applied to the first bit vector for the second message may be the same as the hash algorithms applied to the first bit vector for the first message. Comparing the first bit vector for the second message to Filter Buffer A results in two “no matches.” Filter Buffer A may be read-only and may not be updated based on the first bit vector for the second message. A second bit vector “101001000010” (e.g., a “1” in each of the first, third, sixth, and eleventh indices) for the second message may be generated using hash algorithms associated with Filter Buffer B. The hash algorithms applied to the second bit vector for the second message may be the same as the hash algorithms applied to the first bit vector for the first message. Comparing the second bit vector for the second message to Filter Buffer B results in four “no matches.” Filter Buffer B may be read-only and may not be updated based on the second bit vector for the second message. A third bit vector “1010100000100101” (e.g., a “1” in each of the first, third, fifth, eleventh, fourteenth, and sixteenth indices) for the second message may be generated using hash algorithms associated with Filter Buffer C. Filter Buffer C may have been updated based on the third bit vector for the first message. The hash algorithms applied to the third bit vector for the second message may be the same as the hash algorithms applied to the third bit vector for the first message. Comparing the third bit vector for the second message to Filter Buffer C results in five “matches” and one “no match” (the fourteenth index). Filter Buffer C may be updated based on the third bit vector for the second message. For example, the fourteenth index of Filter Buffer C corresponding to an index of the third bit vector set by the corresponding hash algorithms may be set to include the same value as the corresponding bit vector index. In the current example, this results in setting the fourteenth index of Filter Buffer C to “1.” The updated Filter Buffer C may be used for comparing any future bit vectors for any future received messages.

FIGS. 6A-6C shows examples of filter buffer cluster management. As described above, a filter buffer cluster may comprise one or more filter buffers. In FIG. 6A, the message classification server 140 may monitor updates of all filter buffer clusters. The updates may comprise the updates to the filter buffers in the filter buffer clusters based on the generated bit vectors associated with the corresponding filter buffers. Additionally, each filter buffer cluster may be associated with a database (e.g., a table) that records (e.g., for the cluster as a whole and/or for individual buffers of the cluster) a quantity of messages for which the filter buffer/filter buffer cluster may be used to determine potential correspondences with newly received messages, the expiration dates (e.g., the dates or times that messages expire or are no longer relevant to the content streams associated with the messages) for the messages associated with the filter buffer/filter buffer cluster, and/or a flag and/or other indication of the read-write permission of the filter buffer/filter buffer cluster. For example, if at least one filter buffer in the filter buffer cluster is a read/writable filter buffer, the filter buffer cluster may be a read/writable filter buffer cluster. If none of the filter buffers in the filter buffer cluster is a read/writable filter buffer, the filter buffer cluster may be a read-only filter buffer cluster or in a reservation mode (e.g., none of the filter buffers in the filter buffer cluster is readable or writable). The message classification server 140 may delete (e.g., remove) information (e.g., bits stored one or more filter buffers) in a filter buffer cluster and free up the memory, for example, when all the messages associated with a one or more filter buffers of the filter buffer cluster have reached the corresponding expiration dates. The message classification server 140 may determine and store one or more filter buffer cluster lists comprising addressees (e.g., identifiers, memory locations) of one or more current writing filter buffers and/or filter buffer clusters and current reading filter buffers and/or filter buffer clusters.

The message classification server 140 may set a threshold amount of storage for each filter buffer/filter buffer cluster (e.g., the maximum amount of number of storage for each filter buffer/filter buffer cluster). If a first filter buffer/filter buffer cluster has reached a threshold amount of storage, an additional filter buffer/filter buffer cluster may be created and/or activated and the first filter buffer/filter buffer cluster may be made read-only. Setting a filter buffer cluster as read-only may prevent additional buffers from being created in that filter buffer cluster and/or all the filter buffers in the filter buffer cluster may be read-only.

FIG. 6A shows an example of an initial example state of a filter buffer cluster 620 and a filter buffer cluster 630. The filter buffer cluster 620 may be read/writable because at least one filter buffer in the filter buffer cluster 620 is read/writable. The filter buffer cluster 630 may be in a reservation mode. The message classification server 140 may associate each filter buffer cluster with a unique cluster identifier (e.g., a cluster ID). For example, the filter buffer cluster 620 may be associated with a cluster ID-cluster 1, and the filter buffer cluster 630 may be associated with a cluster ID-cluster 2. The message classification server 140 may store information that indicates which filter buffer clusters currently have read and/or write permissions. In the example of FIG. 6A, the information may comprise a current writing filter buffer cluster address 611 (e.g., cluster 1) and a current reading filter buffer cluster address 612 (e.g., cluster 1).

As described above, if a filter buffer cluster has reached a threshold amount of storage for the filter buffer cluster, an additional filter buffer cluster may be created and/or activated and the filter buffer cluster may be made read-only. In FIG. 6B, if the filter buffer cluster 620 has reached a threshold amount of storage for the filter buffer cluster 620, the message classification server 140 may lock (e.g., block) the writing operation of the filter buffer cluster 620 (e.g., none of the filter buffers in the filter buffer cluster 620 may be writable), and set the filter buffer cluster 620 as read-only (e.g., each of the filter buffers in the filter buffer cluster 620 may be read-only). The filter buffer cluster 630 may be activated and at least one filter buffer in the filter buffer cluster 630 may be read/writable. A received message may be checked against each of the filter buffers in the filter buffer cluster 620 and the filter buffer cluster 630. The check may determine whether the received message is likely to correspond to a previous message. A filter buffer in the filter buffer cluster 630 may be updated based on a bit vector generated using hash algorithms associated with that filter buffer. The state information of the filter buffer cluster 620 and the filter buffer cluster 630 may be updated. For example, the message classification server 140 may modify the current writing filter buffer cluster addresses to not include the filter buffer cluster 620 and only include the filter buffer cluster 630.

The message classification server 140 may monitor the expiration dates of the messages associated with a filter buffer cluster. The message classification server 140 may compare the expiration dates with the current time. Based on the comparison, the message classification server 140 may determine whether any messages have expired. If all the messages associated with the filter buffer cluster have reached the corresponding expiration dates, the message classification server 140 may delete information (e.g., bits stored in each of the filter buffers) and free up the memory of the filter buffer cluster. For example, in FIG. 6C, if all the messages associated with the bit vectors for which the filter buffers of the filter buffer cluster 620 were updated have expired, the message classification server 140 may reclaim the storage (e.g., free up memory resources) of the filter buffers in the filter buffer cluster 620. The filter buffer cluster 620 may then be in a reservation mode (e.g., none of the filter buffers in the filter buffer cluster 620 is readable or writable). The state information of the filter buffer cluster 620 and the filter buffer cluster 630 may be updated. For example, the message classification server 140 may modify the current writing filter buffer cluster addresses and current reading filter buffer cluster addresses to not include the filter buffer cluster 620.

Additionally, if all the messages associated with the bit vectors for which the filter buffers in the filter buffer cluster 620 were updated have expired, the message classification server 140 may reclaim the storage (e.g., free up memory resources) used to store data records associated with those expired messages. The message classification server 140 may reallocate memory of a database (e.g., the database 141) used to store those data records. For example, the message classification server 140 may remove the data record in the database that includes the content of those messages.

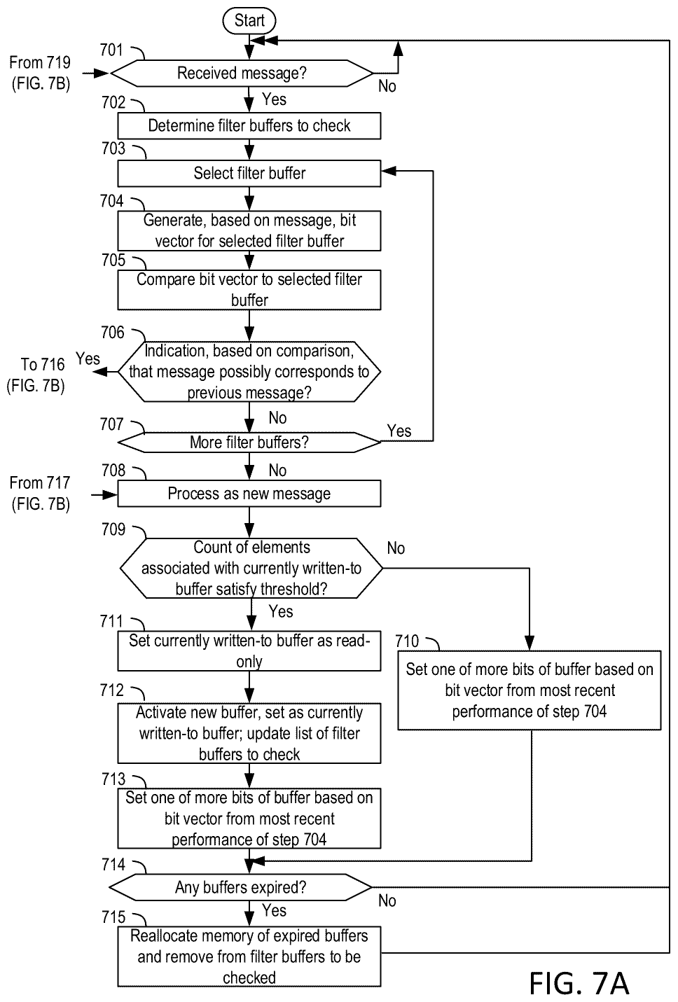

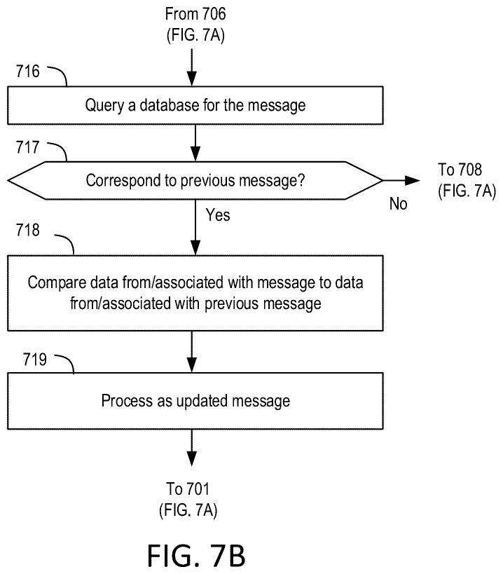

FIGS. 7A and 7B are a flow chart showing steps of an example method, associated with classification and processing of incoming messages, that may comprise some or all steps of methods described above and shown in FIGS. 3-6C. One, some, or all steps of the example method of FIGS. 7A and 7B may be performed by the message classification server 140, and for convenience FIGS. 7A and 7B will be described below in connection with message classification server 140. Also or alternatively, one, some, or all steps of the example method of FIGS. 7A and 7B may be performed by one or more other computing devices. One or more steps may be combined, sub-divided, omitted, or otherwise modified, and/or other steps added. The order of steps may be modified.

At step 701, the message classification server 140 may determine whether a message is received. A message may be received from a third party system (e.g., a third party system 301). A message may indicate one or more content items and may comprise a request for placement of the one or more content items in one or more content streams. A message may comprise a message ID or any other unique identifier that is used by the third party system to identify the placement of the one or more content items. A message may comprise an expiration date (e.g., a date or time that the message expires or is no longer relevant to the content stream associated with the message). A message may comprise information indicating a project to which the message relates. A message ID may be truncated or otherwise modified based on the performance requirement (e.g., the classification speed and/or accuracy requirement) and/or the computational capabilities of the message classification server 140. The message classification server 140 may store a message ID and/or some or all information comprised in or indicated by a message (e.g., information about how one or more content items are to be inserted, information indicating where those content item(s) may be found, and/or other information) in a database (e.g., the database 141).

If the message classification server 140 determines at step 701 that no message has been received, the message classification server 140 may continue to check whether a message is received at a predetermined time interval (e.g., 1 second, 10 seconds, 60 seconds). If the message classification server 140 determines that a message has been received, step 702 may be performed. At step 702, the message classification server 140 may determine filter buffers that are used to check whether the received message is likely to correspond to a previous message. The message classification server 140 may determine a project to which the message is related (e.g., based on information in the message, based on its source, and/or based on other criteria) and determine a filter buffer cluster (e.g., a cluster of a plurality of filter buffers) corresponding to the project. The message classification server 140 may determine an operating status (e.g., access permissions such as read-only, write-only, and/or read/writable) of filter buffers of the filter buffer cluster. If a filter buffer cluster comprises only one filter buffer, the filter buffer may be read/writable. If a filter buffer cluster comprises a plurality of filter buffers, the last created filter buffer may be read/writable, and the remaining filter buffers in the filter buffer cluster may be read-only.

At step 703, the message classification server 140 may select a filter buffer. For example, a filter buffer in the determined filter buffer cluster may be selected to perform the check. For example, as shown in FIG. 5B, a filter buffer cluster may comprise Filter Buffer A, Filter Buffer B, and Filter Buffer C. Filter Buffers A and B may be read-only and Filter Buffer C may be read/writable. In the first iteration of step 703, Filter Buffer A may be selected.

At step 704, the message classification server 140 may generate, based on the message and on k hash algorithms associated with the selected filter buffer, a bit vector for the selected filter buffer. For example, the message classification server 140 may perform k hash algorithms on the message ID based on the selected filter buffer, which may result in a bit vector of the same length of the filter buffer with each of the k hash algorithms mapping the message ID to a different index of the bit vector. For messages with different formats of message IDs (e.g., int type, string type), the generated bit vectors may have the same length (e.g., have the same number of elements in the bit vector).

At step 705, the message classification server 140 may compare the bit vector to the selected filter buffer. For example, the message classification server 140 may determine, for each bit set by one of the k hash algorithms during generation of the bit vector, whether a corresponding index of the selected filter buffer has a non-matching value.

At step 706, the message classification server 140 may determine (e.g., receive an indication), based on the comparison at step 705, whether the message is likely to correspond to a previous message. If for each bit set by one of the k hash algorithms during generation of the bit vector, a corresponding index of the selected filter buffer has a matching value, the message may be determined to likely correspond to a previous message and step 716 (described below) may be performed. If for any bit set by one of the k hash algorithms during generation of the bit vector, a corresponding index of the selected filter buffer has a non-matching value, the message may not correspond to a previous message and step 707 may be performed.

At step 707, the message classification server 140 may determine whether there are one or more additional filter buffers against which the received message should be checked for likely correspondence to a previous message. For example, in FIG. 5B, it may be determined (after checking against Filter Buffer A) that the received message should be checked against Filter Buffer B. If the message classification server 140 determines at step 707 that there is at least one additional filter buffer against which the received message should be checked for likely correspondence to a previous message, steps 703-707 may be repeated. If the message classification server 140 determines at step 707 that there are no additional filter buffers against which the received message should be checked for likely correspondence to a previous message, step 708 may be performed.

At step 708, the message classification server 140 may process the message as a new message. For example, the message classification server 140 may create a data record in a database (e.g., the database 141) by storing instructions, for placement of the one or more content items in one or more content streams, from the message. The message classification server 140 or another computing device (e.g., the content server 106, the app server 107) may execute the instructions by, for example, causing the placement of the one or more content items in one or more content streams. The data record may comprise information for placement/insertion of content items into content streams indicated by the message, and/or a message ID identifying the message.

At step 709, the message classification server 140 may determine whether a count (e.g., a number, a quantity) of elements associated with a currently written-to filter buffer (e.g., the filter buffer selected in the most recent iteration of step 703) satisfies a threshold. The count of elements associated with the currently written-to filter buffer may be the number of previous messages for which the currently written-to filter buffer may be used to determine potential correspondence with a new message, which may be the same as the number of unique bit vectors with which the filter buffer has been updated. The threshold may indicate a maximum number of previous messages for which the currently written-to filter buffer may be used to determine potential correspondence with a new message. The threshold may, as explained above, be a value determined based on a false positive rate associated with the currently written-to filter buffer.

If the count of elements associated with the currently written-to filter buffer does not satisfy the threshold, step 710 may be performed. At step 710, the message classification server 140 may update the currently written-to filter buffer to reflect the new message. For example, the message classification server 140 may set one or more bit values of the currently written-to filter buffer based on the bit vector generated from the most recent performance of step 704.

If the count of elements associated with the currently written-to filter buffer satisfies the threshold, step 711 may be performed. At step 711, the message classification server 140 may set (e.g., designate) the currently written-to filter buffer as read-only. For example, the message classification server 140 may lock the writing operation of the currently written-to filter buffer, and set the currently written-to filter buffer as read-only. In this case, the currently written-to filter buffer may not be updated based on the bit values of any bit vector.

At step 712, the message classification server 140 may activate a new filter buffer (e.g., by generating a new filter buffer and/or by commencing use of a reserved filter buffer), set the new filter buffer as the currently written-to filter buffer, and/or may update the list of filter buffers to check (e.g., during performance of step 707). The message classification server 140 may generate a new filter buffer by, for example, incrementing a quantity of messages associated with a previously-checked filter buffer (e.g. increasing value n for the new filter buffer). A quantity of messages for the new filter buffer may be determined based on a false positive rate associated with the new filter buffer. The new filter buffer may be read/writable. The message classification server 140 may set the new filter buffer or the newly activated filter buffer to be the currently written-to filter buffer. The message classification server 140 may update the list of filter buffers to check for incoming messages. For example, the new filter buffer may be added to the list. At step 713, the message classification server 140 may set one or more bit values of the new filter buffer based on the bit vector generated from the most recent performance of step 704.

At step 714, the message classification server 140 may determine if any filter buffers (e.g., any read-only filter buffers) have expired. For example, the message classification server 140 may determine whether the messages associated with one or more filter buffers have expired based on the expiration dates of the messages. This determination may be made for only read-only buffers because read-only buffers may not be further updated. If all the messages associated with a filter buffer have expired, the filter buffer may be determined as expired. If all the filter buffers in a buffer cluster have expired, the filter buffer cluster may be determined as expired. If no filter buffer has expired, step 701 may be performed.

If at least one filter buffer has expired, step 715 may be performed. At step 715, the message classification server 140 may reallocate memory of the expired filter buffer and/or memory of a database used to store data records associated with messages associated with the expired filter buffer. The message classification server 140 may remove the expired filter buffer from the list of filter buffers to check. A filter buffer may have a certain size (e.g., a memory capacity) and memory may be allocated to the filter buffer based on the size of the filter buffer. If the message classification server 140 determines at step 714 that all filter buffers in the list of filter buffers to check have expired, the method may end after step 715. If at least one filter buffer in the list of filter buffers to check has not expired, step 701 and subsequent steps may be repeated.

As discussed above, step 716 may be performed if a comparison of the bit vector, corresponding to the received message, and the selected filter buffer indicates that the message is likely to correspond to a previous message. At step 716 (FIG. 7B), the message classification server 140 may query the database for the received message. The message classification server 140 may query the database to determine whether the received message is in the database by, for example, using query languages such as SQL. For example, the message classification server 140 may query the database for a data record that contains the message ID of the received message. Based on the query result, and as shown in step 717, the message classification server 140 may determine whether the message corresponds to a previous message in the database. For example, based on a previous message associated with a query result (e.g., if the query returned a data record) having the same message ID as the received message, the received message may be determined to be an update message. If the query does not return a result that indicates a previous message has the same message ID as the received message (e.g., if the query returned no data record), the received message may be determined to not correspond to a message in the database.

If the received message does not correspond to a data record in the database, step 708 may be performed (FIG. 7A). If the received message does correspond to a data record in the database, step 718 may be performed. At step 718, the message classification server 140 may compare the data associated with the message to the data associated with the previous message. The message classification server 140 may retrieve the previous message from the database and extract the data comprised in the previous message. The message classification server 140 may determine, based on the comparison of the data, the differences between the message and the previous message. For example, the message may comprise updated or additional information of an updated version of the content item, an updated schedule for broadcasting the content item or an updated version of the content item, an updated request for placement of the content item in one or more different content streams, and/or an updated budget for placement of the content item in one or more content streams.

At step 719, the message classification server 140 may process the message as an update message. The message classification server 140 may process the message as an update message by changing instructions, for placement of the content item in one or more content streams, from the previous message. For example, the message classification server 140 may change the instructions based on the updated and/or additional information in the message. The message classification server 140 or another computing device (e.g., the content server 106, the app server 107) may execute the instructions immediately or at a specific time. After the message is processed as an update message, step 701 may be performed.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
generating, by a computing device and based on a message indicating a content item, a bit vector comprising a plurality of bit values;
comparing the plurality of bit values of the bit vector to a plurality of bit values in corresponding positions of a filter data set;
determining, based on the comparing, whether the message corresponds to a previous message; and
processing, based on whether the message corresponds to a previous message, the message as one of a new message or an update message regarding a previous message.

2. The method of claim 1, wherein the content item comprises an advertisement and the message comprises a request for placement of the advertisement in one or more content streams.

3. The method of claim 1, wherein:
the generating the bit vector comprises performing a plurality of hash functions on an identifier associated with the message, and
each hash function, of the plurality of hash functions, maps the identifier to a different bit position of the bit vector.

4. The method of claim 1, wherein the determining comprises determining whether any of the plurality of bit values of the bit vector fails to match a corresponding a bit value in the corresponding position of the filter data set.

5. The method of claim 1, wherein:
the generating comprises generating, based on an identifier associated with the message, a plurality of bit vectors,
the comparing comprises preforming, for each bit vector of the plurality of bit vectors, a comparison to a corresponding filter data set of a plurality of filter data sets, and
the determining comprises determining, based on none of the comparisons determining a mismatch between a bit vector and a filter data set, that the message corresponds to a previous message.

6. The method of claim 1, wherein:
the determining comprises determining that the message corresponds to a previous message indicating the content item, and
the processing comprises processing the message as an update message by changing instructions, for placement of the content item in one or more content streams, from the previous message.

7. The method of claim 1, wherein:
the determining comprises determining that the message does not correspond to a previous message, and
the processing comprises processing the message as a new message by storing instructions, for placement of the content item in one or more content streams, from the message.

8. The method of claim 1, further comprising generating, based on an identifier of a second message indicating a content item, a second bit vector comprising a plurality of bit values, wherein:
the generating the bit vector comprises generating the bit vector based on an identifier of the message,
the bit vector and the second bit vector have a same length, and
a format of the identifier of the message is different from a format of the identifier of the second message.

9. The method of claim 8, further comprising determining, based on a comparison of the plurality of bit values of the second bit vector to a plurality of bit values in corresponding positions of the filter data set, whether the second message corresponds to a previous message indicating the content item indicated by the second message.

10. The method of claim 1, wherein the determining comprises determining that the message does not correspond to a previous message indicating the content item, the method further comprising:
setting, based on one or more of the plurality of bit values of the bit vector, one or more of the plurality of bit values in the corresponding positions of the filter data set.

11. The method of claim 1, wherein the determining comprises determining that the message does not correspond to a previous message indicating the content item, the method further comprising:
designating the filter data set as read-only;
generating, based on satisfaction of a threshold by incrementing a quantity of messages associated with the filter data set, a second filter data set; and
determining, based on a comparison of a second bit vector, associated with a second message indicating a content item, and the filter data set, and based on a comparison of a third bit vector, associated with the second message, and the second filter data set, whether the second message is an update to a previous message indicating the content item.

12. The method of claim 1, wherein the determining comprises:
determining that the comparing indicates that the message corresponds to a previous message; and
determining, based on the comparing indicating that the message corresponds to a previous message, and based on a second comparison of additional information from the message to data associated with one or more previous messages, that the message is not an update to a previous message.

13. A method comprising:
determining, by a computing device and based on comparison of a first bit vector, associated with a first message indicating a content item, and a first filter data set, that the first message is a new message;
generating, based on a quantity of messages associated with the first filter data set, a second filter data set; and
setting, based on bit values of a second bit vector, bit values of corresponding bit positions of the second filter data set, wherein the second bit vector is associated with the first message and generated based on the second filter data set.

14. The method of claim 13, further comprising:
determining, based on a comparison of a third bit vector, associated with a second message indicating a content item, and the first filter data set, and based on a comparison of a fourth bit vector, associated with the second message, and the second filter data set, whether the second message is an update to a previous message indicating the content item.

15. The method of claim 13, wherein the determining that the first message is a new message comprises determining whether at least one bit value of the first bit vector does not match a bit value of a corresponding position of the first filter data set.

16. The method of claim 13, further comprising:
generating the first bit vector by performing a plurality of hash functions on an identifier associated with the first message, wherein each hash function, of the plurality of hash functions, maps the identifier to a different bit position of the first bit vector.

17. A method comprising:
generating, by a computing device and based on a message indicating a content item, a bit vector;
determining matches of bit values of the bit vector to corresponding bit values of a filter data set;
comparing, based on the determined matches, additional information from the message to data associated with one or more previous messages; and
storing, based on the comparing, instructions for placement of the content item in one or more content streams.

18. The method of claim 17, wherein the content item comprises an advertisement and the message comprises a request for placement of the advertisement in the one or more content streams.

19. The method of claim 17, wherein:
the generating the bit vector comprises performing a plurality of hash functions on an identifier associated with the message and
each hash function, of the plurality of hash functions, maps the identifier to a different bit position of the bit vector.

20. The method of claim 17, wherein the determining comprises determining that the message likely corresponds to a previous message indicating the content item, and wherein the comparing comprises determining that the message is a new message.
